(19) United States
(12) Patent Application Publication
(10) Pub. No.: US 2010/0073285 A1
(43) Pub. Date: Mar. 25, 2010

(54) DISPLAY DEVICE FOR DISPLAYING A SYSTEM STATE

(75) Inventor: Rüdiger Bertsch, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 12/515,441

(22) PCT Filed: Nov. 29, 2007
(86) PCT No.: PCT/EP2007/062973

§ 371 Date: May 19, 2009

(30) Foreign Application Priority Data
Dec. 4, 2006 (DE) 10 2006 057 097.9

(51) Int. Cl. G09G 5/00; H04R 1/02

(52) U.S. Cl. 345/156; 381/388

(57) ABSTRACT

A display device for displaying a system state has an output unit for reproduction of information characteristic of the system state, a sensor for detecting a distance between a user of the display device and the output unit, and a control unit for processing the reproduction of the information in the output unit as a function of the detected distance.

### CROSS REFERENCE TO RELATED APPLICATIONS

This application is the US National Stage of International Application No. PCT/EP2007/062973 filed Nov. 29, 2007 and claims the benefit thereof. The International Application claims the benefits of German Patent Application No. 10 2006 057 097.9 DE filed Dec. 4, 2006, both of the applications are incorporated by reference herein in their entirety.

### FIELD OF INVENTION

The invention relates to a display device for displaying a system state, it being intended for a current system state of a technical system connected to the display device to be displayed on the display device.

### BACKGROUND OF INVENTION

In a plurality of technical systems, for example in industrial systems or medical systems, measured variables that occur or variables derived therefrom are displayed in order to display a current system state. The term system state here is intended also to include for example measured physiological data of a patient recorded using a medical system. It is necessary to display the system state in order to ensure rapid intervention in particular in the event of the occurrence of a situation requiring attention, e.g. an error or danger. For this purpose it is generally necessary for a human user of the technical system to carry out an appropriate intervention in the technical system or other subsequent measures based on the displayed system state.

With known display devices the display of the system state on the display device is tailored to an optimum viewing distance between the user and the display device. Examples of this are the cockpit of an airplane for example or the control room of an industrial system. Here the display devices, for example screens, are disposed at the optimum viewing distance, so that the user can identify all the information displayed on the display device at the optimum viewing distance. This optimum viewing distance is consequently a fixed viewing distance, from which the display of information is projected on the display device.

### SUMMARY OF INVENTION

If the distance between the display device and the user is variable, the user can frequently not perceive the displayed information optimally. If the viewing distance is too great, the user cannot see information displayed in a small format or information reproduced with inadequate definition and if the viewing distance is short most desired additional information must be retrieved manually, even though it would be possible to display a larger quantity of information simultaneously due to the short viewing distance.

An object of the invention is therefore to specify a display device for displaying a system state, by means of which a user is better able to take in the displayed information.

According to the invention the object is achieved by a display device for displaying a system state, having the following components:

an output unit for the reproduction of information characterizing the system state,
a sensor for capturing a distance between a user of the display device and the output unit,
and a control unit for processing the reproduction of the information on the output unit as a function of the captured distance.

The invention here is based on the consideration of adjusting the displayed information automatically to the distance between the user and the display device, with in particular the information density of the displayed information being automatically adjusted.

A general strategy here is to maximize the density of the displayed information for a short viewing distance and to reduce this information density for a long viewing distance, in that only the most important information with higher priority is then displayed. In this process it is then possible both to vary the format of the display of information and to select a corresponding alternative display form, such as the selection of a symbol in place of an alphanumeric representation.

In one advantageous embodiment the output unit comprises a display unit, for example a screen. The information about the system state to be displayed can be a state or warning message in text and/or graphic form. The information here is advantageously processed by adjusting the display format of the information on the display unit.

It is also particularly advantageous if the processing of the information comprises an adjustment of the information density displayed, so that the information density is maximized for a short viewing distance and the information density is reduced for a long viewing distance.

To achieve an ongoing, automatic adjustment of the display, the information is preferably processed in an ongoing manner, as long as the user is present in a capture range of the sensor.

The approach of the user to the sensor is interpreted here so to speak as a request for detailed information from the display device, like the natural process of “closer viewing”. In the case of an average, regular viewing distance it is thus possible in a simple manner to display a clear display that is “not overloaded”, with additional information only being automatically added as the user approaches the display device. This is particularly advantageous in areas of application where manual interaction with the display device is not desired or possible, for example in a sterile environment during a medical operation in an operating theater.

This can involve mobile medical equipment such as patient monitors, ultrasound systems and C-arms for example. Inventively equipped electronic diagnostic workstations, electronic displays in control rooms or electronic information boards are also possible.

The information density is preferably inversely proportional to the captured distance, so that the approach of the user to the display device triggers the automatic display of a larger quantity of information relating to the system state.

In one particularly preferred embodiment the information is processed in an ongoing manner, as long as the user is present in a capture range of the sensor, so that both the approach of the user to and the distancing of the user from the display device result in a corresponding adjustment of the displayed information.

With a suitable instance of distance capturing, for example by means of an infrared scanner, it is possible for the display device to determine the presence or absence of a human viewer in the detection range of the sensor and thus to identify whether important information can be perceived at all. If not, because the user is absent for example, automatic escalation mechanisms can be triggered, for example the outputting of an acoustic warning tone, emergency operation of the system, emergency shutdown or electronic notification to the user, or even the outputting of the information on a further output unit, which can be a long way away from the output unit.

Therefore in one preferred embodiment the invention results in a display device, with which when the captured distance=infinite, the absence of the user is concluded and the information is reproduced on a further output unit.

The output unit and/or the further output unit here can comprise a loudspeaker, with the information being output as an acoustic state or warning message on the loudspeaker and with information processing comprising an adjustment of the sound characteristic of the information for reproduction on the loudspeaker.

The adjustment of the sound characteristic here can comprise a reproduction volume, a tone level, an envelope curve, a modulation, a reproduction speed or a tone sequence of the information.

For example different tone melodies may be associated with different state messages, so that the user can identify the start of a specified system state from the melody.

In this process the volume can be increased for example, when the user moves away from the display device. It is also possible to lower the tone level, when the distance between the user and the display device increases, as lower tones can be perceived more readily than high ones at a longer distance. However this is also a function of the acoustic characteristics of the environment of the display device, so that higher tones may be more effective as the distance increases, due to resonance effects for example.

The invention also results in a method for displaying a system state on a display device, with the following steps:

determining the system state,
determining the distance between the user of the display device and an output unit of the display device, and
reproducing the system state on the output unit, with at least one characteristic of the reproduction being a function of the determined distance.

The characteristic of the reproduction here can comprise the information density of the reproduction of the system state.

In this process the information density is preferably inversely proportional to the determined distance.

The characteristic of the reproduction is particularly preferably adjusted in an ongoing manner, as long as the user is present in a capture range of a sensor for determining the distance.

To summarize, the invention can be outlined as follows:

The distance between the user and the display device is captured, preferably continuously, and the display of information on the output unit is adjusted continuously as a function of the captured distance. The adjustment here can consist for example of setting the information density of the information for display on the output unit. The adjustment can also consist of selecting a specific display form, for example the selection of a graphic symbol instead of an alphanumeric character chain.

The display device ensures that the information can be identified in a wide range of distances between a user and the display device. The resulting display of information is clear and appropriate to requirements. The user can interact in a contactless manner with the display device by varying the viewing distance. Automatic activation of escalation mechanisms is also possible, if important information cannot be perceived due to too great a viewing distance (the extreme instance being when the user is absent).

### BRIEF DESCRIPTION OF THE DRAWINGS

An exemplary embodiment of the invention is described in more detail below.

In the figures:

FIG. 1 shows a display device and

FIGS. 2-6 show displays on the output unit as a function of the distance of the user.

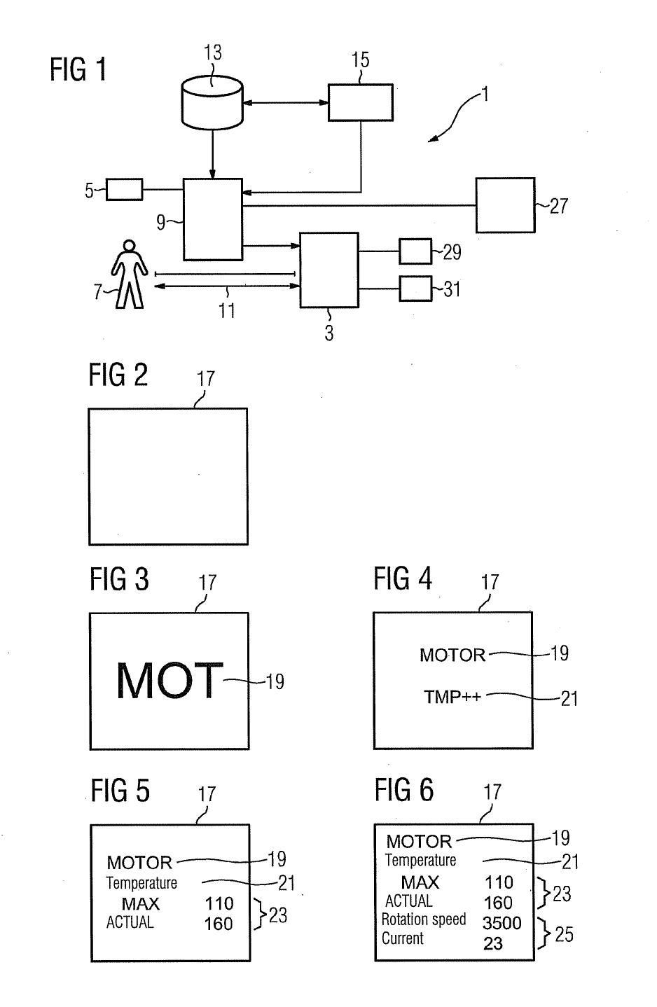

### DETAILED DESCRIPTION OF INVENTION

A display device 1 comprises an output unit 3, a sensor 5 for determining a distance 11 between a user 7 and the output unit 3 and a control unit 9 for adjusting the reproduction of the information on the output unit 3. If the user 7 moves away from the output unit 3, as determined by the sensor 5, the reproduction of the information characterizing the system state on the output unit 3 is adjusted, for example by reducing the information density of the information for reproduction on the output unit 3. Conversely the information density can be increased, when the user 7 approaches the output unit 3.

As well as a visual display of the information, an acoustic reproduction of the information is alternatively or additionally possible, for example on the output unit 3 and/or on a further output unit 27. In the present example the output unit 3 comprises both a display unit 29 for the graphic reproduction of the information and also a loudspeaker 31 for simultaneous or alternative reproduction of the information as an acoustic message.

The further output unit 27 can likewise comprise a graphic output unit and/or an acoustic output unit.

If it is determined by means of the sensor 5 that the user 7 has exceeded a predetermined maximum distance from the output unit 3, the display of information on the further output unit 27 can be initiated, the further output unit 27 being located in a different room for example, where the user is assumed to be, for example a control center.

The information characterizing the system state can be stored in its entirety in an information pool 13, from which the information characterizing the current system state is transferred to the control unit 9. The transfer of the current system state can be effected for example by means of an information controller 15, which is connected to the technical system (not shown in detail).

FIGS. 2 to 6 show examples of the adjustment of the displayed information on the output unit 3.

A continuous reduction in the viewing distance between the user and the output unit 3 is assumed here.

A temperature error of a motor of the technical system is deemed to be present.

In FIG. 2 the user 7 is a very long distance from the output unit 3. The above-mentioned system error is displayed here simply as a red area 17 on the output unit 3. This red area can be perceived by the user even at a very long viewing distance.

The user now approaches the output unit 3.

FIG. 3 again shows the red area 17, with information relating to an error source 19 now being added, visualized here for example by the upper case letters MOT as an abbreviation for motor. At a long viewing distance as in FIG. 2b the user can now identify rather more than at the very long viewing distance in FIG. 2a: the user can now see that there is a motor error.

The user now approaches closer to the output unit 3 and in FIG. 3 is at an average viewing distance from the output unit 3. Now more detailed information is superimposed on the red area 17, for example the error source 19 in the form of the full word “Motor” and the data “TMP++” as the cause of the error 21. Compared with FIGS. 2 and 3 the information density of the display on the output unit 3 has been increased as the distance decreases.

FIG. 4 is intended to correspond to a close viewing distance, with the information density being further increased. For example the cause of the error 21 is now displayed as the full word “Temperature” and error variables 23 are also indicated, such as a maximum temperature 110 and an actual temperature 160 for example.

At a close viewing distance according to FIG. 4 all the essential error information is available at a glance to the user, who can see all of it with one glance.

If the user now comes closer to the output unit 3, moving to a very close viewing distance from the output unit 3, even more operating parameters 25 can be superimposed, for example a rotation speed or current.

1.-12. (canceled)

13. A display device for displaying a system state, comprising:
an output unit for a reproduction of information characterizing the system state;
a sensor for capturing a distance between a user of the display device and the output unit; and
a control unit for processing the reproduction of the information on the output unit as a function of the captured distance.

14. The display device as claimed in claim 13, wherein the output unit comprises a display unit.

15. The display device as claimed in claim 13, wherein the information is a state message in text or graphic form.

16. The display unit as claimed in claim 13, wherein the information is a warning message in text or graphic form.

17. The display unit as claimed in claim 13, wherein the processing of the information comprises an adjustment of the display format of the information on the display unit.

18. The display device as claimed in claim 13, wherein the processing of the information comprises an adjustment of the information density displayed.

19. The display device as claimed in claim 14, wherein the processing of the information comprises an adjustment of the information density displayed.

20. The display device as claimed in claim 13, wherein the information density is adjusted in an inversely proportional manner to the captured distance.

21. The display device as claimed in claim 19, wherein the information density is adjusted in an inversely proportional manner to the captured distance.

22. The display device as claimed in claim 13, wherein the information is processed in an ongoing manner, as long as the user is present in a capture range of the sensor.

23. The display device as claimed in claim 13, wherein, when the captured distance is equal to infinite, the absence of the user is concluded and the information is reproduced on a further output unit.

24. The display device as claimed in claim 13, wherein the output unit comprises a loudspeaker, the information is an acoustic state or warning message, and the processing of the information comprises an adjustment of a sound characteristic of the information for reproduction by means of the loudspeaker.

25. The display device as claimed in claim 24, wherein the sound characteristic comprises a reproduction volume, a tone level, an envelope curve, a modulation, a reproduction speed or a tone sequence of the information.

26. A method of displaying a system state on a display device, comprising:
determining the system state;
determining a distance between a user of the display device and an output unit of the display device; and
reproducing the system state on the output unit, with at least one characteristic of the reproduction being a function of the determined distance.

27. The method as claimed in claim 26, wherein the characteristic of the reproduction comprises the information density of the reproduction of the system state.

28. The method as claimed in claim 27, wherein the information density is set such that it is inversely proportional to the determined distance.

29. The method as claimed in claim 26, wherein the characteristic of the reproduction is adjusted in an ongoing manner, as long as the user is present in a capture range of a sensor for determining the distance.
